(19) United States
(12) Patent Application Publication
(10) Pub. No.: US 2005/0049785 A1
(43) Pub. Date: Mar. 3, 2005

(54) Off-board navigation system

(76) Inventor: William E. Vergin, Sterling Heights, MI (US)

Correspondence Address: PATTON BOGGS LLP, 2550 M STREET NW, WASHINGTON, DC, 20037-1350, US

(21) Appl. No.: 10/651,993

(22) Filed: Sep. 2, 2003

(51) Int. Cl. G01C 21/34

(52) U.S. Cl. 701/209; 701/202; 340/995.19

(57) ABSTRACT

An off-board navigation system including, in a vehicle, a user interface, a geographic location detection apparatus, for generating a position data representing the position of the vehicle, and a wireless transmitter/receiver, and call receiving center remote from the vehicle. The call receiving center includes a wireless transmitter/receiver, a roadmap database, and a processor for calculating road routes based on the roadmap database. A user in the vehicle transmits a route request to the call receiving center. The vehicle position data is communicated from the vehicle to the call receiving center. The call receiving center calculates a route based on the route request and the vehicle position data received from the vehicle over the wireless data. The route is transmitted from the call receiving center to the vehicle.

### FIELD OF THE INVENTION

This invention relates to navigation systems and, more particularly, to navigation by sending route queries from users at mobile positions, receiving the queries at a remote site, and generating and transmitting route information to the users based on an off-board route database.

### BACKGROUND OF THE INVENTION

Conventional navigation systems for use in automobiles, trucks and other vehicles typically include a display, an on-board database of map data (Map Database), a Global Positioning System (GPS) receiver, and processors for calculating positions and routes based on the GPS data and the map data. The systems operate by the GPS receiver processing signals from at least four, and typically eight or more of the 24 to 27 Earth-orbiting GPS satellites and, based on known processing methods, generating position data in units of, for example, degrees longitude and latitude. The onboard Map Database includes information for displaying on, for example, the video display roads and, in some systems, points of interest. The system includes data for associating the roads, and points of interest if used, to the longitude and latitude data, or other geographical position data generated by the GPS receiver. Based on the geographical location of the vehicle as determined by the GPS receiver the processor retrieves data from the Map Database corresponding to a geographical area surrounding that location and displays a map with the vehicle represented as, for example, a cursor point on the map. The system may include a zoom feature for the user to adjust the map field.

Such conventional systems keep track of the current position of the vehicle by receiving the GPS signals and decoding these into a geographic position data. The geographic position data accesses an on-board database having map data for the vicinity in which the vehicle is traveling. The map data and the geographic position data are then displayed to the user so that the car, or other vehicle, appears as a position marker on a street map. When the driver needs directions, he or she can enter the destination using either of two primary methods. The first method uses the street address of the desired destination. In this case, the user enters the street address via a keypad. The system then searches the onboard data based and if the location is found, generates a route, and provides a “turn-by-turn” direction from the current position vehicle to its desired destination. As an alternative, the second primary method, called “points of interest”, can be used. In the “points of interest” method, the user knows the name of the destination, e.g. name of hotel, airport, museum, restaurant, etc. and enters the name of the destination by way of the keypad. The system searches the onboard “points of interest” data base and if the location is found, generates a route and provides “turn-by-turn” directions from the current position of the vehicle to the desired destination. The system then accesses the on-board database, calculates a route and provides “turn-by-turn” directions to the user.

Moreover, presently there are three methods of providing “turn-by-turn” directions to the user. The first uses audio prompts. When an audio prompt system is used, it will, as the vehicle is approaching a desired turn, state, for example, “right turn in one-half a mile”. Another audio prompt will occur at say one quarter a mile from the turn, and finally when the vehicle is nearing the turn junction, the system may provide audio chime(s). The second method for providing “turn-by-turn” directions provides text messages. Similar to the audio prompts, the vehicle's information display will show changing distances to the maneuver function and identify the name of the street where the turn is to occur. The third method, shows a graphical display of the intersection at which a turn is to be made in order to further clarify the directions and maneuver.

The conventional system has shortcomings. One is that the systems use DVD-based, or CD-based, mapping systems. CD and DVD based systems have moving parts, which are susceptible to failure in the environment to which they are subjected as due to use in a vehicle subjects. In addition, since the CDs or DVDs are the entire data universe from which the systems operate, these require regular software updates, i.e., disc replacement, to stay current with road changes. A related shortcoming is that the on-board map data base, due to its cost/space constraints, and the impracticality posed by processing requirements, does not maintain a real-time database of traffic conditions and situations, such as accidents, construction and the like.

### SUMMARY OF THE INVENTION

One example embodiment includes one or more call receiving centers for receiving route query data and transmitting route instruction data, an off-board map data base for retrievably storing map data, a first data communication link from said one or more call receiving centers to said off-board map data base, and an off-board route calculator for generating the route instruction data based on the route query data and the map data. The route query data includes user location data and user destination data. The example embodiment further includes a wireless network for communicating the route query data and route instruction data between the call receiving centers and a local navigation system which is described in greater detail in connection with FIG. 3. The local navigation system is preferably installed on a vehicle, and includes a location signal receiver, a local controller, a human sensory interface, a voice/data transmitter/receiver for receiving query inputs from a user and for transmitting, in response, route query data to the wireless network for receipt by one or more of the call receiving centers. A local data bus connects the voice/data transmitter/receiver, the local controller and the human sensory interface. The voice/data transmitter/receiver further receives the route instruction data from the wireless network and stores it, via the local data bus, in the local controller. The local data bus transfers the route instruction data to the human sensory interface that generates, in response, a command sequence perceptible to human senses.

### BRIEF DESCRIPTION OF THE DRAWINGS

The foregoing and other objects, aspects, and advantages will be better understood from the following description of preferred embodiments of the invention with reference to the drawings, in which:

FIG. 1 depicts a high level functional block diagram of an example off-board navigation system;

FIG. 2 shows a vehicle local navigation systems' alternative technologies and modes for wireless communication with a call center's road map database;

FIG. 3 depicts a high level functional block diagram of an example vehicle local subsystem of the FIG. 1 example off-board navigation system;

FIG. 4 shows an example hardware architecture for a vehicle local subsystem of the FIG. 1 example off-board navigation system;

FIG. 5 shows a high level flow chart of an example method of off-board navigation using, for example the FIG. 1 system; and

FIG. 6 shows another example flow chart for an example method, using the described and depicted off-board navigation system of FIG. 1-3.

### DETAILED DESCRIPTION

Examples are described referencing the attached functional block diagrams and flow charts. Example hardware implementations are also described. The description provides persons skilled in the arts pertaining to navigation systems with the information required to practice the claimed systems and methods. The use of specific examples is solely to assist in understanding the described and claimed systems and methods. Persons skilled in the art, however, will readily identify further specific examples, alternate hardware implementations, and alternate arrangements of the functional blocks that are within the scope of the appended claims. The specific examples, therefore, do not limit the alternate hardware implementations of the described system and/or it methods of operation, including presenting navigation and related information to the user.

Description of a feature, aspect or characteristic which references “one embodiment” or “an embodiment” means, unless otherwise described, that the subject feature, aspect or characteristic is included in at least one, but not necessarily any particular, embodiment. Further, the occurrence of the phrase “one embodiment” in various places in this description does not, unless it is clear from the context, mean that each refers to the same embodiment.

It will be understood that, unless otherwise stated, the terms “installed” and “included” encompass permanent mounting, temporary or removable mounting, semi-permanent mounting, and co-locating of hardware and, with reference to a system or function, a subsystem, feature or function “installed” or “included” in a system does not necessarily mean that the hardware for carrying out the subsystem, feature or function is co-located with the hardware of that into which it is “installed” or “included.”

The described system and method provides quick, understandable presentation to the user of complete directions from the user's location to his or her desired destination(s). The system utilizes a geographic location device, such as a Global Positioning System (GPS) receiver, installed in the user's vehicle, and a wireless communication system, such as a cell phone system, for the user to send a request to a call center. The request includes the destination information provided by the user, typically in response to queries from the call center, and automatically includes the user's location as detected by the geographic location device. The call center includes a map database of road map data and, optionally, a database of road conditions. The database of road conditions, if used, may include, or be based upon, real-time road condition data provided by, for example, governmental transportation authorities. The call center further includes, and/or has access to, a processing resource for retrieving road map data from the map database and, optionally, the road condition data, and for calculating a route using one or more selection and optimization algorithms.

A local controller is installed in the user's vehicle. The local controller may be installed at time of manufacture, by the dealer, or as an after-market item. Other example implementations of the local controller include a portable device, such as a personal digital assistant (PDA), as will be described. The local controller has a local processing resource and a local data storage. An information presentation apparatus such as, for example, a display screen and/or an audio speaker, is installed in, or located in, the vehicle. The information presentation apparatus may, for example, be embodied by a feature of the vehicle's entertainment electronics. A user interface is also installed in the vehicle, for the user to enter commands to the navigation system. The user interface may be a microphone, for voice-activated operation, a keypad or a touch screen. The touch screen may, for example, be a feature of the video display screen used for the information presentation apparatus.

In an illustration of an example method, the user speaks the words “I need directions,” whereupon a voice activation feature of the local controller contacting the call center over, for example, the wireless link available through the user's cell phone. The local controller carries out contacting the call center by activating the user's cell phone to dial a pre-stored number, which places a call to a designated call center. The call is placed and the local controller automatically obtains position data from the vehicle's on-board GPS receiver, and sends a request for services data, having the position data, to the call center over the channel established by the cell phone connection. Optional features include the local controller calculating a vehicle direction, speed data, and identification data, and including this in the communication contacting the call center. A live or automatic operator at the call center receives the call, with the vehicle's location data and, optionally, vehicle direction and speed date, and sends an inquiry to the vehicle. An example inquiry, for presentation to the user through the vehicle's speaker, is “Hello, I see that you are on Smith Street at the corner of Smith Street and 1^{st} Avenue in Newville, State. Where would you like to go?.”

An example direction request, from the user, to the above example query from the call center, is “3508 North Grant Street, Newville.” The call center, in response to the example user direction request, enters the provided street address, or data corresponding to the provided street address, into its processing resource. The processing resource searches the map database and assembles a route using the user vehicle present location, and direction information, if available, along with the destination street address. The call center then sends ROUTE data to the user's vehicle, through the communication channel formed by the cell phone call being between the user's vehicle and the call center. The ROUTE data may include further information such as, for example, a distance data indicating the road distance, along the calculated route, from the user's present location to the destination.

The vehicle's local controller stores the ROUTE data from the cell phone into the controller's local storage and, either while still receiving the ROUTE or upon completion, formats the ROUTE data for presentation on the video display or audio speaker, or both. For example, the local controller may generate audio data based on the ROUTE data such that the user hears, “Please turn around when you get to the intersection of Smith Street and 8^{th} Avenue, and proceed back in the direction you came until you get to 4^{th} Avenue, where you will take a left turn.” The visual ROUTE data, showing the vehicle's present position and at least a portion of the area roads, is displayed on the video display if present. The call center continues to download the ROUTE data until it is completed. The cell phone connection between the vehicle's local controller and the call center may be terminated, continued for further queries, or periodically re-established based on defined events. Further features and aspects are described in greater detail below.

Storing and maintaining the map database remote from the vehicle removes the expense and trouble of each user having to purchase, install, and periodically update a copy of the entire map database local to the vehicle. Likewise, calculating and identifying routes at a processing resource remote from the vehicle, and then transferring the information to the vehicle for presentation to the user, permits processing of routes that is faster, using higher level, computationally intensive, selection and optimization algorithms, at a lower cost than that attainable using on-board processing. For added system robustness the call center may download map data describing at least a subset of the roads within a geographical region surrounding the user, and the local controller may itself include limited route selection features. This permits continued, albeit reduced performance, operation if the user is temporarily cut-off from using the wireless network.

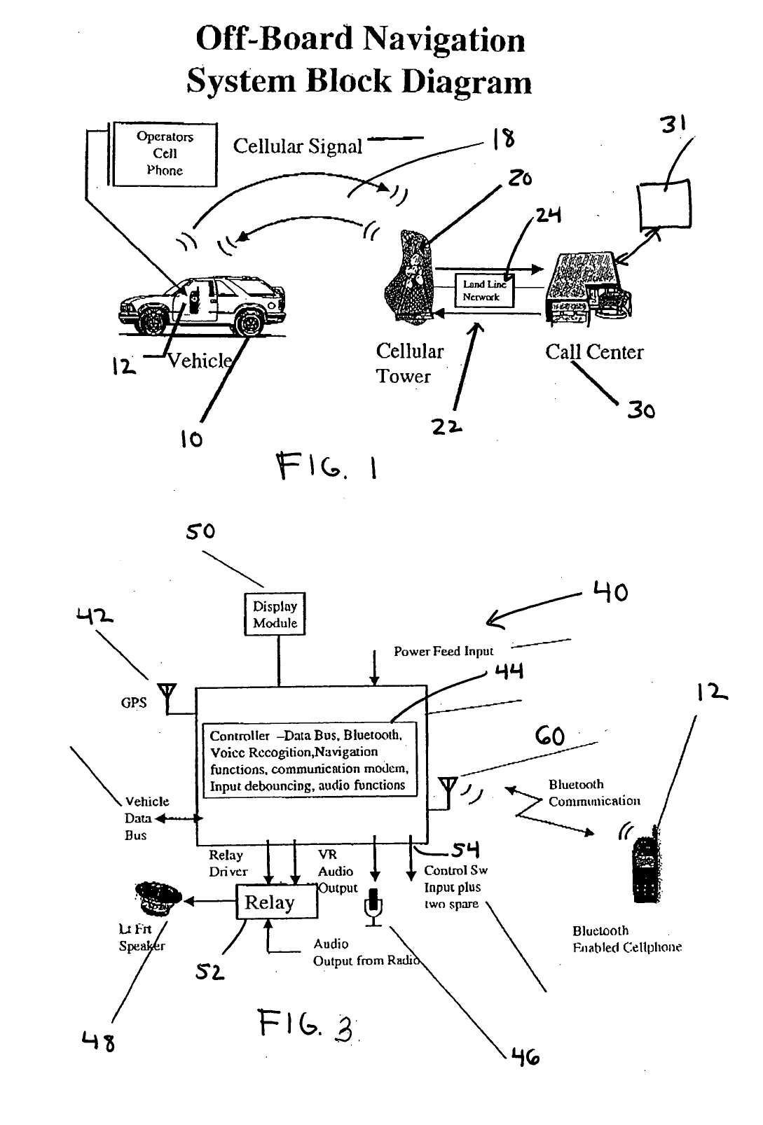

FIG. 1 depicts a high-level functional block diagram of an example off-board navigation system. The FIG. 1 diagram presents functional blocks to assist in describing the system and in understanding operations and features. The FIG. 1 block diagram is broken down according to function and does not, unless otherwise stated or made clear from the context, describe or define hardware implementations of the system. For example, grouping functions into the FIG. 1 blocks does not, unless otherwise described or specified, mean that the group of functions with the blocks are carried out by one particular hardware unit, and does not necessarily mean the functions are carried out in a time sequence corresponding to the physical arrangement of the blocks on the figure.

Referring to FIG. 1, an example system includes a user (not labeled), who may be the driver or passenger within a vehicle 10. The user has a data communication device 12, preferably portable, such as, for example, a cell phone. For this description the phrase “cell phone 12” means “the example cell phone implementation of the data communication device 12.” A control module (not shown in FIG. 1) is installed, either removably or semi-fixed, in the vehicle 10. The vehicle 10 includes a position detection unit (not shown in FIG. 1) such as, for example, a Global Positioning System (GPS) receiver, which generates a signal POS(t) uniquely representing the geographical position of the vehicle 10 at time t. The vehicle 10 further includes an optional compass-heading unit (not shown in FIG. 1) that generates a signal VDIR(t), representing the compass pointing direction of the vehicle 10 at time t. The vehicle 10 still further includes an identification signal generator (not shown in FIG. 1) generating a signal IDENT(u), where u uniquely identifies the specific vehicle 10.

A remote data link 18 connects the communication device 12, e.g., the cell phone, to a network node 20 of a wide-area communication system 22. For this example the communication device 12 is a cell phone and, therefore, the wide-area communication system 22 is a cellular communication network, such as AT&T Wireless™ or Cingular™, and the network node 20 is a cell phone tower. The remote data link 18 is, for this example, realized by the voice channel made available to each user of a conventional cell phone communication system.

FIG. 1 shows only one cell tower 20, which is in accordance with standard cellular telephone systems' assigning of a caller to only one cell tower at a time, typically the cell tower closest to the user. As also known in the art, cellular telephone systems typically operate a plurality of cell towers, spaced at intervals achieving approximately complete coverage over a predetermined system area and, as a user moves through the area, he or she is passed from one cell tower to another. The remote data link 18 carries voice communications between the user and the call center 30 described below, as well as position information POS(t) from the vehicle 10 to the call center 30, and ROUTE data from the call center 30 to the user. The remote data link also carries the optional vehicle and/or user identification data IDENT(u) and vehicle compass heading data VDIR(t). Link 24 represents the landline link from and between various ones of the cell towers.

Item 30 is the call center. The call center 30 includes one or more operators or more automated voice operator systems to interact with the user, one or communications modems to transmit data to the vehicle, a ROADMAP database including maps, address lists and, optionally, traffic information and points of interest. The call center 30 further includes a computer resource 31 to calculate the desired or available routes, and generate the corresponding ROUTE data for transmission to the user.

There is no specific constraint on the hardware implementation of the computing resources 31 of the call center 30 other than processing power to calculate the route data in an acceptable length of time. The computing resource 31 may include one or more general purpose programmable computers such as, for example, Intel™ Pentium-based personal computers having video display and a data entry device, such as a keyboard and/or mouse, running under the Windows XP™ or Linux™ operating system. Also, it will be understood that computing resource 31 may be a single hardware unit connected to a local or remote storage, or distributed storage for the ROADMAP database, or a network of computers, or a thin client or “mainframe” computer with a plurality of user terminals. The specific hardware arrangements and architectures to implement a call center 30 that can process a given number of users, at a given statistical response time, are readily identified by persons skilled in the arts of user interactions and user-accessible databases. Example considerations, all of which are well known in the relevant engineering arts are anticipated user load, the number of described features included, and cost factors.

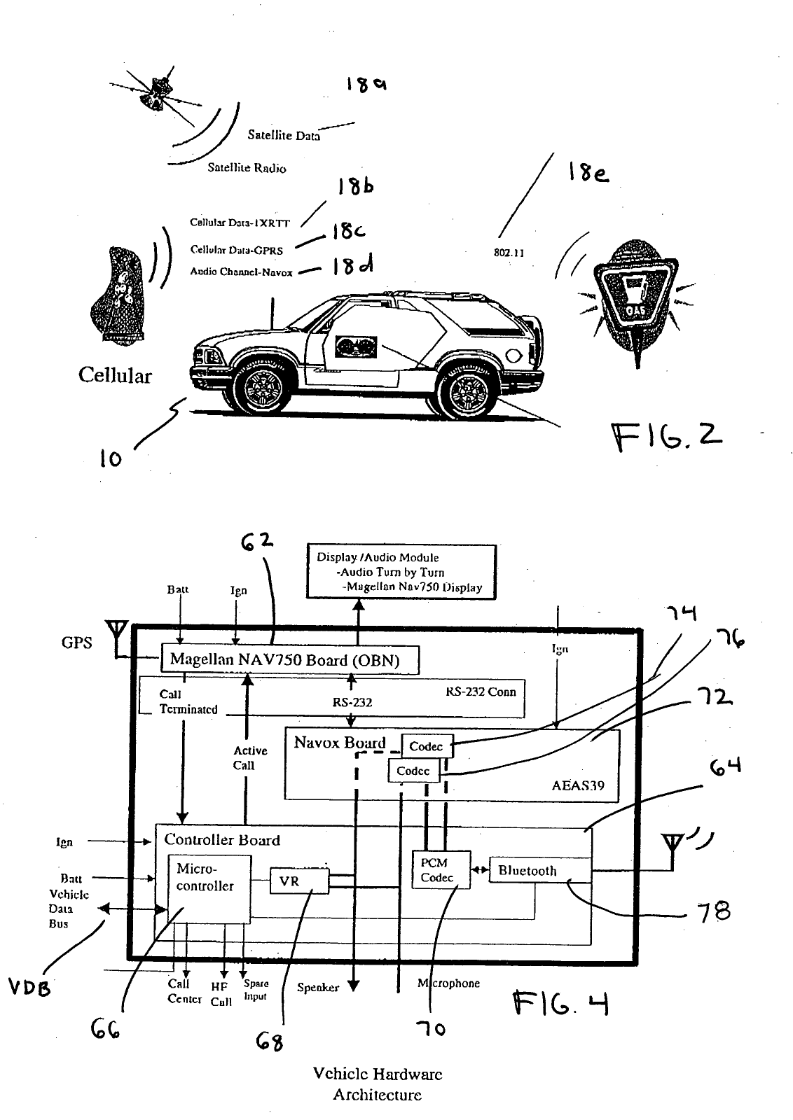

FIG. 2 shows alternative technologies and modes for implementing the wireless link 18 between the vehicle 10 and call center 30. The alternative technologies include satellite radio and data 18a, cellular data “1XRTT”, labeled 18b, cellular data “GPRS”, labeled 18c, and cellular audio channel “Navox”, labeled 18d. The options further include, but are not limited to, “802.11”, labeled as 18e.

FIG. 3. shows an example functional block diagram of the local navigational subsystem 40 installed in the FIG. 1 vehicle 10. Each function block that appears in both FIG. 1 and in FIG. 3 is labeled identically.

Referring to FIG. 3, the depicted example local navigational subsystem 40 includes an antenna 42, mounted to the vehicle for receiving signals from which the POS(t) signal identifying vehicle 10's location can be determined. An example is GPS signals. FIG. 3 shows a single antenna 42 but, depending on the specific location carrying signals received by the system, a plurality of antenna may be used. The structure, materials, and arrangement of antenna for receiving location information signals, such as the signals transmitted by GPS satellites, are well known in the art to which this system pertains. A local controller 44 receives the GPS signals and, among other functions described in greater detail below, calculates the POS(t) data. The format of the POS(t) data is a design choice, but use of an industry format such as, for example GPS exchange (GPX) may be preferable for ease of data transfer.

With continuing reference to FIG. 3, the depicted example local navigation system 40 further includes a microphone 46, an audio speaker 48, and a video display or display module 50. The video display 50 may be any display screen technology usable in vehicles such as, for example, a liquid crystal display (LCD) or a heads-up display. The microphone 46 enables hands-free reception of voice commands and queries from the user. The audio speaker 48 enables audio presentation to the user of data and queries and from the call center 30. The audio speaker 48 also enables audio presentation of navigation instructions from the local controller 44, after the instructions are, or while they are being, downloaded from the call center 30. The video display 50 may be omitted, and the local navigation system 40 implemented using only audible command receipt and instruction generation, as described below.

The FIG. 3 example embodiment includes a further feature of using at least one of the audio entertainment speakers (not separately labeled) typically installed in the vehicle 10 as the speaker 48. This feature is implemented by a relay or switch 52 that, under the control of the RSWITCH output of the local controller 44, switches the feed to the one or more audio entertainment speakers (not numbered).

The FIG. 3 depicted local navigational system 40 further includes a control switch input 54. The switch 54 may be implemented, for example, as a pressure-sensitive switch mounted on the vehicle dashboard, or as a touch screen feature of the video display 50. By activating this switch 54 the user sends a STARTREQ signal to the local controller 44 to initiate a navigational request call to the call center 30. If the communication link between the local controller 44 and the call center 30 is realized by a cell phone, such as the cell phone 12 shown in FIG. 3, the call center phone number or numbers CCNUMBER may be stored, for example, in the local controller 44. The storage may be carried at time of manufacture, or programmed by, for example, an aftermarket dealer or the vehicle dealer. A plurality of alternative call center phone numbers CCNUMBER may be stored such that the local controller 44, when encountering, for example, a “busy” signal will retry the call with the next alternate CCNUMBER. Further, the CCNUMBER may be stored in the user's cell phone 12.

A local link 60 connects the cell phone 12 to the local controller 44. The link 60 may be a short-distance wireless connection such as, for example, a Bluetooth, a proprietary wireless link, or a hardwire connection. An example Bluetooth-enabled cell phone for implementing the cell phone 12 is the Nokia™ T68. Preferably the link 60, whether wireless or wired, uses a conventional protocol such as that included with commercially available, off-the-shelf communication devices 12, such as the example cell phone.

In the FIG. 3 example local system, the vehicle's local controller 44 establishes calls to the call center 30 by sending a STARTCALL through, for example, the depicted Bluetooth connection 60 to the user's cell phone 12. The STARTCALL may include the CCNUMBER or, if the CCNUMBER is stored in the cell phone, an identifier for the CCNUMBER. The cell phone 12 in response, dials the CCNUMBER and connects the driver to the call center 30.

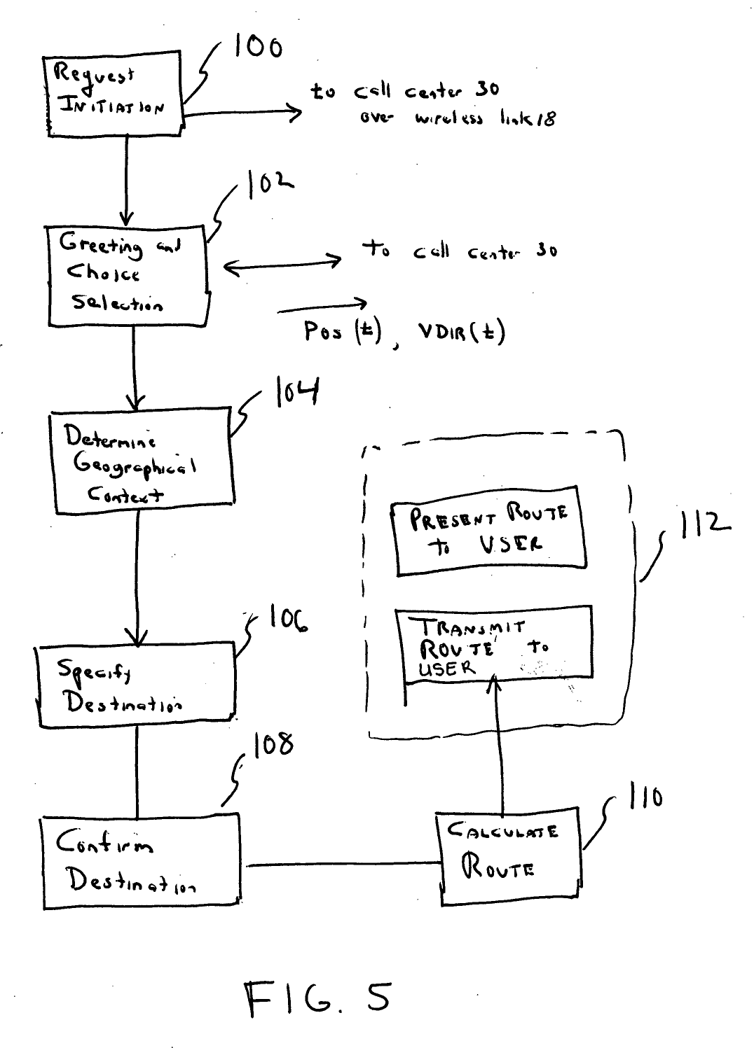

FIG. 4 shows an example hardware architecture for the local controller 44 function of the FIG. 3 example vehicle local subsystem 40. The FIG. 4 example hardware architecture includes a GPS receiver 62 such as, for example, a Magellan™ NAV750 Board, or equivalent. The FIG. 4 example further includes a controller board 64 having a microcontroller 66, a voice recognition unit 68 a PCM codec 70, and a Bluetooth transceiver 78. The microcontroller 64 has a port (not labeled) connected to the vehicle data bus VDB. Example vehicle data bus formats are “DCX” and “GM 1850”, which are known in the automotive arts. A Navox™ board 72 includes codecs 74 and 76.

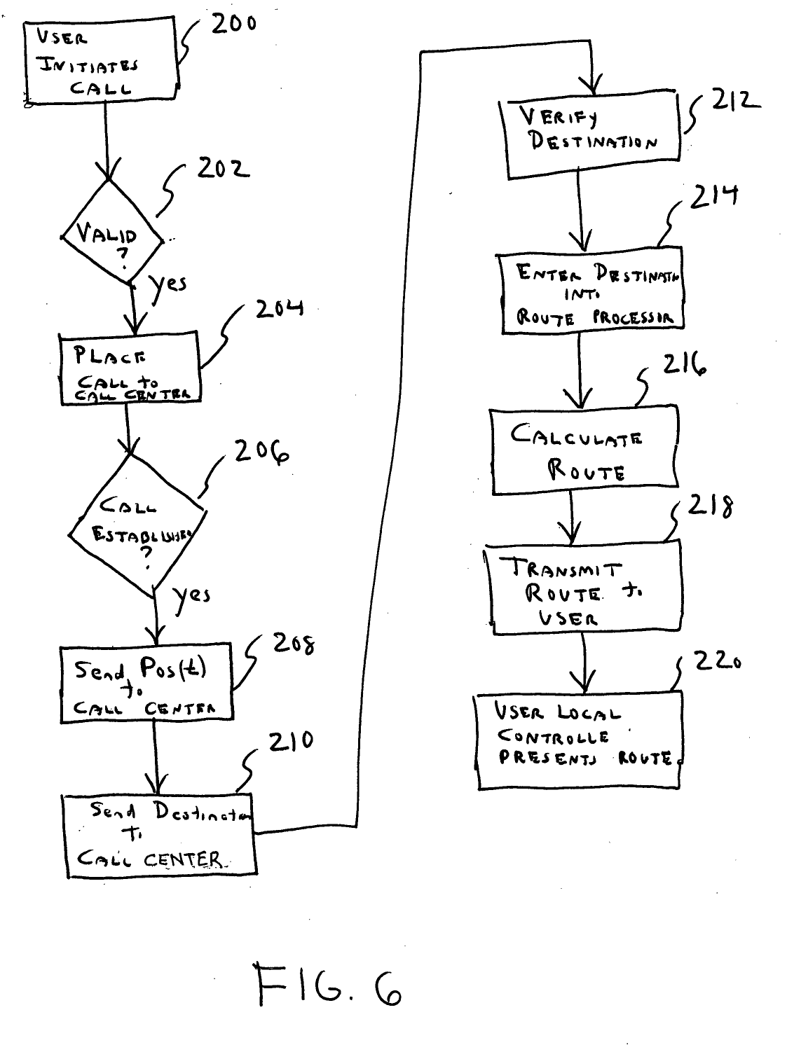

FIG. 5 shows a high level flow chart of an example method of off-board navigation, which may be carried out on the FIG. 1 system. Referring to FIG. 5, method begins with the On-Board Request Initiation block 100, which initiates a wireless communication from the user's vehicle to the call center 30. The communication can be done, for example, using the cell phone 12 shown in FIG. 1, either by the user directly dialing the phone or by the user employing a vehicle local controller, such as the local controller 44 of FIG. 3, linked to the cell phone, such as the FIG. 3 example Bluetooth link 60. Next, at the Greeting and Choice Selection block 102 the call center 30 acknowledges or confirms receipt of the call from the user's vehicle, and queries the user to identify which navigation service the user requests. An example is the operator stating “Hello Mr. Smith, this is Alice at Acme Telematics. How can I assist you today?”, to which Mr. Smith replies “Hello Alice. I need directions.” The block 102 communications between the user and the call center 30 are carried out over, for example, the cellular network example of FIG. 3.

Next, at the Determining the Geographical Context block 104 the call center 30 identifies the user's specific geographical location. Example operations for block 104 are the user transmitting his or her location data to the call center, the call center receiving the location data and, depending on the data format, translating it into a street location. It is contemplated that the call center 30, if using a human operator, would retrieve a map from its roadmap database corresponding to the location data and display this on an operator video screen. It is further contemplated that the call center would send a verification statement to the user after identifying the street location from which the user was calling. Referring to the FIG. 1 and FIG. 3, an example illustrative sequence for carrying out block 104 is the local controller 44 sending the GPS POS(t) data to the call center. The transmission may be done concurrently with operation of blocks 100 and 102.

Assuming, for purposes of this example, a human operator at the call center 30, the operator either manually enters the POS(t) into the call center's computing resource 31, or the POS(t) can be automatically stripped out of the communications received from the user and input to the computer resource 31. The operator, after seeing the street address and/or a map display showing the user's vehicle, queries the user with a statement, for example: “I see that you are in Smallville, at the corner of 1^{st} and Main. Would you like a destination in Smalville, or are you going somewhere else?” An example user reply is: “I am going to Metropolis.” If the vehicle 10 includes a compass-heading unit generating VDIR(t), the operator is enabled to state “I see that you are on Smaliville, at the corner of 1^{st} and Main, heading north. Would you like a destination in Smaliville, or are you going somewhere else?”

After identifying the geographical context, the Specify the Destination block 106 specifies the user's destination. Continuing with the example query-response content, an example for carrying out block 106 is a statement from the call center 30 of “What can I find for you in Metropolis?” with an example reply from the user of “I would like to go to 123 Market Street.” Next, Confirm the Destination block 108 confirms or verifies the destination specified by the user. The confirmed destination is referenced as DEST. An example for carrying out block 108 is that call center operator enters “123 Market Street, Metropolis” into the ROADMAP database to identify if, in fact, such an address exists. If the address exists, an example statement confirming query from the call center 30 is “I found 123 Market. It is in the Downtown section of Metropolis. I will transmit the directions in a moment.” Another example response from the call center 30 includes a request for final confirmation from the user such as, for example, “Does this sound right to you?”, to which the user responds with a “yes” or a “no”. Another example response from the call center 30 includes a query for any additional requests from the user.” An example of such a query is: “Is there anything else that I can help you with?”

With respect to a query from the call center 30 of: “Is there anything else that I can help you with?”, the types of replying requests from the user include, for example, “How far is it?” and “Is there a gas station along the way?” The first could be answered, or estimated, prior to the call center 30 initiating the block 110 calculations of the ROUTE data described below. The call center 30's answer to a question such as the first could be the prompting factor for the second question of “Is there a gas station along the way?” Embodiments of the ROADMAP database are contemplated which have entries for business establishments such as, for example gas stations and restaurants, thereby enabling answers to such user questions. It is further contemplated that the block 110 calculations, or selection of routes, i.e., ROUTE data, includes accommodating user needs such as gas stations and restaurants.

The above description references blocks 104 and 106 as separate. It is contemplated, though, that blocks 104 and 106 may be merged, wherein the operator at the call center 30 states a single query of, for example: “I see that you are on Smith Avenue, near the intersection with 2^{nd} Street, in Smaliville. Where would you like to go?” The user would reply, for example, with: “I would like to go to 123 Market Street in Metropolis.”

It will be further understood that the functions represented by blocks 106 and 108 are not necessarily completed through a single query/reply. Instead, the functions represented by block 106 and 108 entail a substantially open-ended dialogue such as, for example, a typical “411” information dialogue. As an illustrative example, the call center's ROADMAP database may show no entry for “123 Market Street,” and, instead, show a “132 Market Street.” The specific forms of a typical continuing dialogue between the call center 30 and a user depends, in part, on the amount of descriptive information in the ROADMAP database associated with individual addresses. For example, it is contemplated that the ROADMAP database would include public records associated with individual addresses. One example would be the name of the property owners. Depending on privacy concerns, an example query by the user, continuing with example above, using such information would be “The 132 Market Street address, is Mr. Adams the listed owner?” The call center would, for example, answer the user's question with a “yes” or a “no”, whereupon the dialogue would end or continue. Other example information that could be included in the call center's ROADMAP database are the phone numbers, if any, associated with an address.

It is still further contemplated that the dialogue in a typical performance of the block 106 and 108 functions includes provisions for user questions such as “Well Tom said that his place, which is 123 Market Street, is about four miles north of East High School. How does this match the 132 Market Street that you found?” The call center 30 would respond by entering the “East High School” name into its ROADMAP database, and calculating the distance.

With continuing reference to FIG. 5, after the destination is confirmed by block 108, and the dialogue or communications between the call center 30 and the user establish that there are no further requests from the user, block 110 calculates the ROUTE data, which describes a route from the user's position POS(t) to the location represented by the DEST data. The route calculation is performed by, for example, any of the known route calculation methods known to persons skilled in the arts pertaining to road navigation systems. Typical methods assign fixed weights to road sections or segments. Typical weighting factors include, for example, speed limits, the number of traffic lights, average traffic load conditions. Block 110 is contemplated as further including variable weight assignment to road sections and segments. Contemplated examples are predetermined time dependence, such as certain roads having traffic congestion at certain times of the day, or roads having lane assignments that vary on weekends and/or the time of day. Such data is detected and collected, in many municipalities, from traffic cameras and police reports, and is made available on, for example, a subscription basis.

The route calculation 110 then selects a route, represented by ROUTE, having the lowest estimated time of travel from the user's present location POS(t) to the destination DEST. The route calculation 110 preferably receives regularly updated POS(t) data from the user's vehicle, as shown by the arrow labeled “Updated POS(t) data”. One reason for sending updated POS(t) data is that, depending on the speed and direction of the vehicle, the user's vehicle may pass intersections that change the calculations for the ROUTE data.

The ROUTE data may further include data describing landmarks and desirable points of interest. Such landmarks and desirable points of interest, in addition to assisting in the block 104, 106 and 108 queries, can make the ROUTE instructions more interesting and reassuring when presented to the user. For example, if a ROUTE data is presented to the user in a form such as “We see that you are still heading north on Richmond Avenue. To get to 1367 Westview Street turn left at Avon St, which is about a half-mile ahead of you, at a traffic light. There will be an Exxon station at the intersection. Then go about a mile, until you get to Adams St. It is directly before a Texaco station.” One or more of such landmarks, typically for each major intersection, are readily incorporable into the ROADMAP database.

The ROUTE data is then, at block 112, transmitted from the call center 30 to the vehicle for audio and/or visual presentation to the user. An example audio presentation is by the speaker 48 shown in FIG. 3, under the control of the local controller 44. The block 112 transmission and presentation are contemplated as being concurrent or overlapping, due to the anticipated need for the user to receive the first instruction of the turn-by-turn instructions before the time delay required for transmitting the entire ROUTE data.

FIG. 6 shows another example flow chart for an example method, using the described and depicted off-board navigation system of FIG. 1-4. It will be understood that the term “user” in the FIG. 6 example flow chart may be the driver or a passenger of the vehicle, or both.

Referring to FIG. 6, the example method begins at block 200 where the user initiates a call to the call center 30 by, for example, pressing the call request switch 54 or by speaking an appropriate voice command such as, for example, “DIRECTIONS PLEASE” into the microphone 46 which is detected by the voice recognition feature 68. In response the local controller 44 analyzes the switch signal or the voice command. To analyze if the switch signal is valid, the local controller can de-bounce the switch signal. Following a defined de-bounce period, if the switch signal is still present, the system will accept the signal as being valid. If the local controller 44 determines the switch signal or voice command valid then, at block 202, the local controller 44 sends a message through, for example, the Bluetooth connection 60 to the Bluetooth enabled cell phone 12. The cell phone 12 then, at block 204, sends a call to the call center 30 by way of the cell tower 20. The cell phone system, such as, for example, the FIG. 1 system 22, routes the call to the call center 30, using wireless and landline links as known in the art. The local controller 44 waits, at block 206, for establishment of the call. If the call is established it proceeds to block 208 whereupon it sends the current POS(t) position data, e.g., the GPS position at time t, to the call center 30. Also, if the FIG. 3 example audio presentation feature of using a vehicle entertainment speaker is used, the local controller 44 sends a speaker source switch 52, which makes the local controller 44 the source of audio for the entertainment speaker implementation of item 48.

As described above, the call center 30 can be implemented with a human operator and/or an automated operator. To facilitate a ready understanding of the method, the FIG. 6 flow chart will be first described using a human operator. Preferably, as will be understood from this description, the human operator is not required to make substantive judgments querying or providing directions and other described information to the user. Instead, the human operator simply carries out query driven actions and responses, which are based on predetermined logic rules that will be understood upon reading this description.

Referring to FIG. 6, when the POS(t) data is received at the call center it is displayed on a video display in front of the human operator. The display operation uses the POS(t) data to retrieve a road map data from the ROADMAP database of the call center 30. Since the human operator at the call center 30 may perform better with a visible map showing the location of the user, the ROADMAP database stores information from which a visible road map can be generated for all areas covered by the FIG. 1. The video display shows, preferably, a zoom-in/zoom-out road map of an area local to the position of the vehicle, which is represented by the POS(t) data. The position of the vehicle is shown by, for example, a flashing “X”. If the vehicle includes the compass-heading unit for generating the VDIR(t), identifying the compass heading of the vehicle, the VDIR(t) is included in the transmission from the vehicle 10. Information such as, for example, a rotating compass arrow cursor, would be displayed to the call center operator. Still further, if the ROADMAP data includes road condition data, this may be presented to the call center operator as, for example, an overlay.

With continuing reference to FIGS. 3 and 6, at the completion of step 208 the operator at the call center 30 sees on his or her video display a road map of an area local to the POS(t) position of the vehicle with, for example, a flashing “X” representing the vehicle. The user then, at block 210, states a desired destination to the call center 30 operator. A typical example operation of block 210 is the call operator stating “I see you on the screen, you are heading north on Richmond Avenue, between First Street and Second Street. Where would you like to go?” The operator query would be transmitted from the call center 30, through the wireless link 18 of FIG. 1, to the cell phone 12, then over the FIG. 3 Bluetooth link 60, to the local controller 44 and then presented, for example, through the audio speaker 48 to the user. The user replies by stating, for example, “I would like to go to 1367 Westview Street.” If the user did not know the street address of the desired destination then he or she could state, for example, “I would like to go to Saint Lutheran's Church, I think it's somewhere near Fairview Hospital.”

At the flow block labeled 212 the call center operator identifies the desired destination using the ROADMAP database and enters it, or its co-ordinates, into the computing resources 31 of the call center 30. The format of the co-ordinates is a design choice. The format and sequence by which the call center operator finds the desired destination is a design choice, based in part on the types of information that can be received from the user. For example, a simple system would accommodate only specific street addresses, such as the “1367 Westview Street” of the above example. An example format and sequence for function block 212 is for the operator to type the street address provided by the user, such as “1367 Westview Street” into a data-entry field appearing on the video display. Design of such data entry fields, for concurrent display with the visual road map of the area surrounding the vehicle position POS(t), is well known in the computer arts. The computer resource 31 would then search the ROADMAP database and retrieve the location, DEST, corresponding to the entered destination address. Searches of this type are well known and, therefore, detailed description is not necessary.

The format of the DEST data is a design choice, depending in part on the format required for input into route calculation block 216 described below. For example, if the block 216 route calculation accepts street addresses, such as, for example, “1367 Westview Street,” then the DEST data could be only a verification indicator, whereupon the call center operator would enter the street address into the computing resource 31 for route calculation.

A contemplated further feature of block 212 is that the operator, after obtaining the DEST data corresponding to the destination descriptor provided by the user at block 210, will transmit a verifying query to the user. An example verifying query is “I found 1367 Westview Street, it is about 15 miles north of you, in a residential area. Does this sound correct?” The user would respond with either a confirmation, such as “Yes,” or a non-confirmation such as “That sounds too far to me, and I thought it was south of here.” If the latter occurred, further queries could be used to correct, for example, a spelling error. To accommodate spelling issues, the method contemplates a natural language based search which locates a predetermined number of hits that correspond to the street address provided by the user. Truncated word and other search methods such as this are known in the general art of database queries.

Referring to FIG. 6, at function block 214 the call center operator enters the location data DEST, either the data obtained from the ROADMAP database or the street address as described above, into the computer resource 31. Then, at block 216, the computing resource 31 calculates the ROUTE data, which describes a route from the user's position POS(t) to the location represented by the DEST data. As described above in reference to FIG. 5, the route calculation is performed by, for example, any of the known route calculation methods known to persons skilled in the arts pertaining to road navigation systems. Typical methods assign fixed weights to road sections or segments, the weighting factors including, for example, speed limits, the number of traffic lights, average traffic load conditions, as well as variable weightings such as traffic conditions. The route calculation of step 216 then selects a route, represented by ROUTE, having the lowest estimated time of travel from the user's present location POS(t) to the destination DEST.

Referring to FIGS. 1 and 6, block 216 preferably receives regularly updated POS(t) data from the user's vehicle 10, as shown by the arrow labeled “Updated POS(t) data”. The local controller 44 carries out the regular updates. One reason for sending updated POS(t) data is that, depending on the speed and direction of the vehicle 10, and the processing time required for block 216, the users vehicle may pass intersections that change the calculations for the ROUTE data.

At the completion of block 216 the ROUTE data is ready for transmission from the call center 30 to the local controller 44 in user's vehicle. The ROUTE data preferably includes turn-by-turn instructions and, optionally, data for visual display of the route to the user. As described above the ROUTE data may further include data describing landmarks and points of interest.

Referring to FIGS. 1 and 6, the call center operator at block 218 transmits the ROUTE data to the vehicle's local controller 44 by, for example, pressing a button or clicking on a screen icon on the video display (not labeled) of the computing resource 31. The ROUTE data is then transmitted over, for example, the land line connection 24 from the cell phone service provider, through the cell phone network 22 over the last wireless link 18 from the cell tower 20 closest to the user, to the user's cell phone 12. By sending the ROUTE data over the voice channel established by the cell phone connection the need for expensive wireless connections such as, for example GPRS or 3G, is eliminated. As the ROUTE data is received by the local controller 44 it proceeds to carry out the presentation of the ROUTE data to the user at block 120. It will be understood that blocks 218 and 220 may overlap, i.e., early-received ROUTE data may be presented to the user while further ROUTE data is being received.

A contemplated further feature of blocks 218 and 220 is for one or both of the local controller 44 and the call center computing resource 31 to monitor the integrity of the ROUTE data received by the local controller and/or the integrity of the voice/data channel established by the cell phone 12 between the controller 44 and the computing resource 31. An example of such monitoring is to embed parity, or other error-detection code bits into the ROUTE data and program a parity or error correction operation into the local controller 44. Depending on design choice, the local controller 44 may be programmed to send an error detection signal back to the call center upon detecting an error in, or interruption of, the ROUTE data. Alternatively, the local controller 44 may send a periodic signal verification data in the absence of detecting an error in the ROUTE data. Then, upon detecting an error, the call center and/or the local controller 44 may initiate a resend. Error detection and resend schemes suitable for these purposes are well known in the communication arts and, therefore, further detailed description is not necessary.

As described above, the ROUTE data preferably includes turn-by-turn instructions and, optionally, data for visual display of the route to the user. This enables the local controller 44 to quickly begin presenting audible instructions to the user, through the speaker 48, or a visible portion of a map, for display on the video display 50, representing the ROUTE data. The driver can then start on the route represented by ROUTE while the remainder of the data is still being sent. This feature is particularly important if the voice channel of the cell phone 12, which typically has a relatively small bandwidth, is used for transmitting the ROUTE from the call center 30 to the user at block 218. A design consideration for this feature is that ROUTE data not be so large that it cannot be completely downloaded before the user gets to his or her destination. Further to this consideration is that each turn-by-turn instruction must be presented to the vehicle user before the turn arrives.

The local controller 44 preferably performs the following operations and functions during the information presentation block 220:
integration of the visual map information contained in the ROUTE into a\ contiguous map;
regular comparison of the updated POS(t) data from, for example, the GPS receiver 42 with the positions represented by the ROUTE data. This done for two reasons, one being to alert the driver if he or she is off-course, the other being to align the marker on the vehicle's visual display representing the vehicle with the visual representation of the road. The latter is typically required due to inaccuracies in the GPS data and discrepancies between the actual physical location of roads and their location as represented by the data in the ROADMAP database.
Timed presentations of the turn-by-turn directions to the user, either by voice or other audio command through the speaker 48 or via the video display 50, or both, by comparing the vehicle's POS(t) location with the location of the next turn to be instructed by the turn-by-turn instructions. A contemplated further feature of the block 220 instruction presentation is a countdown timer, or distance indicator to show an upcoming turn.
Notification to the driver that the destination has been reached, which may include a countdown timer or distance indicator.

Referring to FIGS. 1 and 3, the above-described methods are not limited to using cell phones for the wireless link 18 between the vehicle 10 and the call center 30. Other technologies may substitute for, or supplement, the cell phone implementation. One example is a satellite phone system, using either geostationary or low earth orbiting satellites such as, for example, Iridium. Advantages of satellite phone systems are coverage area and bandwidth.

Another is cellular data. In addition to using the voice channel of the cell phone, there are dedicated services that transmit data over the wireless network. These services include GPRS and 1XRTT. Navox technology is used to transmit data over the voice channel of the cellular network. Still another technology to substitute for, or supplement using the voice channel of standard cellular network telephone links is 802.11. The 802.11 wireless standard is used widely in local area networks, typically for wireless connection of PCs to networks.

Advantages of the above described method include elimination of a map database in the vehicle, with commensurate reduction in cost and increase in reliability. A further benefit is the vehicle has continuous access to optimized routes based on up-to-date information in the ROADMAP database accessible by the call center 30.

Those skilled in the arts pertaining to the above-described navigation systems and methods understand that the preferred embodiments described above may be modified, without departing from the true scope and spirit of the description and claims, and that the particular embodiments shown in the drawings and described within this specification are for purposes of example and should not be construed to limit the claims below.

1. A navigation method comprising:
providing a motor vehicle with a location signal receiver for receiving externally generated location signals and a location processor for generating a location data based on the received location signals;
providing a map database having a plurality of road data representing a plurality of roads;
providing a call receiving center;
providing a wide area network including a wireless link to the motor vehicle;
receiving said location signals at said location signal receiver;
generating location data based on said received location signals;
communicating, through the wireless link, a route request signal from the motor vehicle to the call-receiving center, the route request including the location data and a destination identifier;
retrieving at said call-receiving center, at least a subplurality of the road data in response to said received route request signal;
generating a route data based on said retrieved road data, said location data and said destination identifier;
transmitting the route data to said motor vehicle, through at least said wireless link, to the motor vehicle;
presenting route instruction information to the user based on said route data.

2. A method according to claim 1 wherein said communicating includes transmitting an initial request from the user to the call center, transmitting a destination inquiry from the call center to the user in response to the initial request, and transmitting a reply request from the user to the call center in response to the destination inquiry, the reply request including the destination identifier.

3. A method according to claim 1 further including receiving an externally generated traffic condition data and wherein said route data is generated further based on said received traffic condition data.

4. A method according to claim 1 further includes receiving an externally generated traffic condition data wherein said route data includes a traffic condition description data based on said traffic condition data, and wherein said presenting route information further presents a route traffic condition information to the user representing said traffic condition description data.

5. A method according to claim 4 further including transmitting an alternate route inquiry from said call center to said user, and presenting an alternate route inquiry information to the user in response.

6. A method according to claim 1 further including calculating a distance-to-destination value based on said location data and said route, and presenting distance to-go information to the user based on said distance-to-destination.

7. A method according to claim 1, further including automatically generating an updated location data based on said received location signals and automatically sending a route verification signal from the motor vehicle to the call center, through the wireless link, the route verification signal including said updated location data, verifying the updated location data to reflect a position valid based on the route data, and transmitting a route deviation alert to the motor vehicle

8. A method according to claim 1, wherein the transmitting the route data to said motor vehicle, through at least said wireless link, to the motor vehicle overlaps with said presenting route instruction information to the user based on said route data.

9. A method according to claim 1, wherein communicating includes:
communicating over said wireless link a first route request signal including the location data;
communicating from said call center, over said wireless link, a first query;
communicating from said motor vehicle to said call center, over said wireless link, a response to said first query, said response including a destination data;
determining, at said call center, whether or not said destination data represents a valid address;
communicating a result of said determining, from said call center to said motor vehicle, over said wireless link.
